(19) United States
(12) Patent Application Publication
(10) Pub. No.: US 2010/0011406 A1
(43) Pub. Date: Jan. 14, 2010

(54) METHOD FOR FEEDING BACK FAILURES OF SET-TOP BOXES

(75) Inventors: Liang-Chyi Lin, Tu-Cheng (TW); Shih-Pin Chen, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/332,351

(22) Filed: Dec. 11, 2008

(30) Foreign Application Priority Data
Jul. 11, 2008 (CN) 200810302706.8

(51) Int. Cl. H04N 7/173

(52) U.S. Cl. 725/134

(57) ABSTRACT

A method for feeding back failures of a set-top box (STB), includes: providing a Universal Serial Bus (USB) storage device with a diagnostic program and a reporting program; inserting the USB storage device into the STB; loading the diagnostic program from the USB storage device to the STB; running the diagnostic program to find failures within the STB; writing the failures of the STB to the USB storage device; inserting the USB storage device into a network device; and running the reporting program by the network device to feed back the failures of the STB to a remote server.

### BACKGROUND

1. Field of the Invention

Embodiments of the present disclosure relate to set-top boxes (STBs), and more particularly to a method for feeding back failures of a STB.

2. Description of Related Art

With the rapid development of broadband technologies, digital set-top boxes (STBs) employing broadband technologies are now in widespread use. Digital STBs allow users to order and watch a variety of TV or film programs. STB failures, on the other hand, create inconveniences for users.

Presently, with regards to an STB without a function for feeding back failures of the STB, a diagnostic program is stored in a memory of the STB to detect failures within the STB. If the diagnostic program in the memory is defective, the failures of the STB cannot be detected. It will be very difficult for STB operators to know the failures of the STB in such a case because the STB does not have the function of feeding back its failures.

### SUMMARY

An embodiment of the present disclosure provides a method for feeding back failures of a set-top box (STB) to a remote server. The method includes the steps of: providing a Universal Serial Bus (USB) storage device configured with a diagnostic program and a reporting program; receiving and loading the diagnostic program from the USB storage device to the STB; running the diagnostic program for determining whether at least one failure exists in the STB; writing the failure of the STB to the USB storage device if at least one failure exists; receiving the USB storage device in a network device connected with an electronic communication network; and running the reporting program using the network device to feedback the failure of the STB to the remote server.

Other advantages and novel features of the present disclosure will become more apparent from the following detailed description when taken in conjunction with the accompanying drawings, in which:

### BRIEF DESCRIPTION OF THE DRAWINGS

FIG. 1 is a schematic diagram of an application environment of a method for feeding back failures of a set-top box; and

FIG. 2 and FIG. 3 are flowcharts of a method for feeding back failures of a set-top box of the present disclosure.

### DETAILED DESCRIPTION OF CERTAIN INVENTIVE EMBODIMENTS

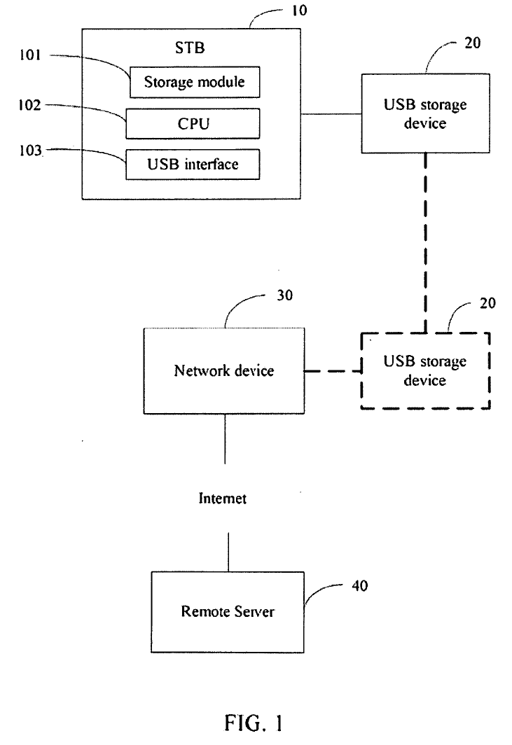

FIG. 1 is a schematic diagram of an application environment of a method for feeding back failures of a set-top box (STB) 10. In this embodiment, the method for feeding back failures of the STB 10 is applied in a system which includes the STB 10, a Universal Serial Bus (USB) storage device 20, a network device 30, and a remote server 40. In the illustrated embodiment, the STB 10 is not connected to an electronic communication network.

The USB storage device 20 is capable of being inserted into the STB 10, and is also capable of being inserted into the network device 30 for exchanging data therebetween. The USB storage device 20 acts as a forwarding tool to transfer the failures of the STB 10 to the network device 30 and the remote server 40. As such, maintainers of the STB 10 on the side of the remote server 40 would receive information on the failures of the STB 10 in a timely manner.

In this embodiment, the STB 10 includes a storage module 101, a central processing unit (CPU) 102, and a USB interface 103. The STB 10 is not able to communicate with the remote server 40 over the electronic communication network. A diagnostic program and a failure reporting program of the STB 10 are stored in the USB storage device 20.

The USB storage device 20 can communicate with the STB 10 via the USB interface 103. The STB 10 boots up and initializes the USB storage device 20 when the USB storage device 20 is inserted into the STB 10.

The CPU 102 is used for loading the diagnostic program from the USB device 20 to the storage module 101, running the diagnostic program to determine whether any failures exist in the STB 10, and writing the diagnostic result to the USB storage device 20. The diagnostic result includes the failures of the STB 10.

The storage module 101 is used for storing the diagnostic program and other related files related to the diagnostic files and the STB 1O. In this embodiment, the storage module 101 may be a synchronous dynamic random access memory (SDRAM). After storing the diagnostic result on the USB storage device 20, the device is pulled out from the STB 10 and is then inserted into the network device 30. The network device 30 subsequently runs the failure reporting program in the USB storage device 20 for feeding back the diagnostic results to the remote server 40.

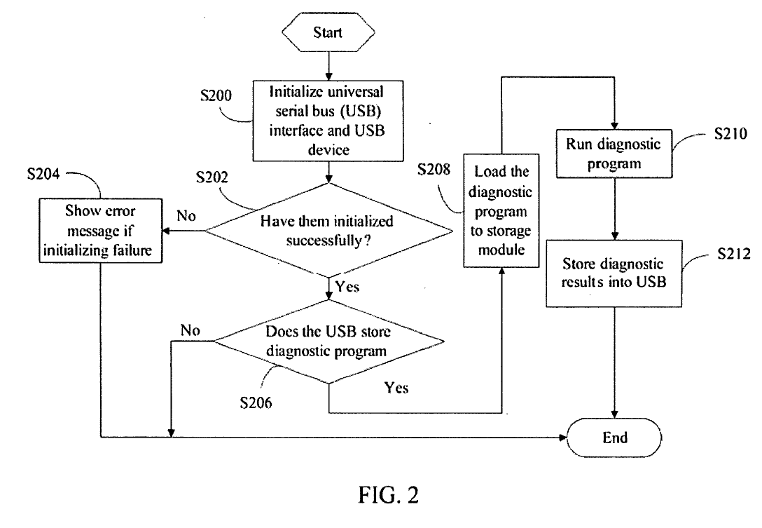

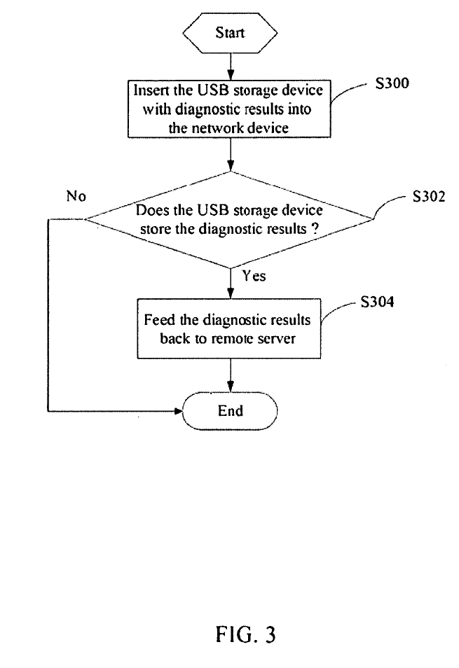

FIG. 2 and FIG. 3 are flowcharts of a method for feeding back failures of the STB 10. Depending on the embodiment, additional steps may be added, others deleted, and the ordering of the steps may be changed. The USB storage device 20 is inserted into the STB 10 prior to implementing the method.

In step S200, the STB 10 boots up and initializes the USB storage device 20 and the USB interface 103.

In step S202, the STB 10 determines whether the USB storage device 20 and the USB interface 103 have been initialized successfully.

If the USB storage device 20 and the USB interface 103 have not been successfully initialized, the STB 10 displays a failure message in the block S204.

If the USB storage device 20 and the USB interface 103 have been initialized successfully, the STB 10 determines whether the USB storage device 20 stores the diagnostic program in the step S206.

If the USB storage device 20 stores the diagnostic program, the STB 10 loads the diagnostic program to the storage module 101 in the block S208.

In the block S210, the STB 10 runs the diagnostic program for determining whether there is at least one failure.

In the block S212, the STB 10 writes the diagnostic results to the USB storage device 20. In one embodiment, the diagnostic results include the failures of the STB 10.

In this embodiment, when the diagnostic process is completed, the diagnostic program automatically terminates, and the USB storage device 20 can be removed from STB 10.

In step S300 of FIG. 3, the USB storage device 20 is inserted into the network device 30.

In step S302, the network device 30 determines whether the USB storage device 20 stores the diagnostic results.

If the USB storage device 20 has not stored the diagnostic results, the process is completed.

If the USB storage device 20 has stored the diagnostic results, the network device 30 runs the reporting program to feed back the diagnostic results to the remote server 40 in step S304. In this embodiment, the reporting program automatically exits when the feeding back process is completed. Thus, STB operators would obtain the diagnostic results, namely the failures of the STB 10, in a timely manner.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A method for feeding back failures of a set-top box (STB) to a remote server, the method comprising:
providing a Universal Serial Bus (USB) storage device configured with a diagnostic program and a reporting program;
receiving and loading the diagnostic program from the USB storage device to the STB;
running the diagnostic program for determining whether at least one failure exists in the STB;
writing the failure of the STB to the USB storage device if at least one failure exists;
receiving the USB storage device in a network device connected with an electronic communication network; and
running the reporting program using the network device to feedback the failure of the STB to the remote server.

2. The method as claimed in claim 1, further comprising:
initializing the USB storage device when the STB boots up.

3. The method as claimed in claim 1, further comprising:
terminating the diagnostic program automatically after the diagnostic process is completed.

4. The method as claimed in claim 1, further comprising:
terminating the reporting program automatically after the feeding back process is completed.
